(19) United States
(12) Patent Application Publication
(10) Pub. No.: US 2010/0055565 A1
(43) Pub. Date: Mar. 4, 2010

(54) ELECTRODE MANUFACTURING METHOD AND ELECTRODE

(75) Inventors: Katsuo NAOI, Tokyo (JP); Kazutoshi EMOTO, Tokyo (JP); Kiyonori HINOKI, Tokyo (JP); Masahiro SAEGUSA, Tokyo (JP); Kenji NISHIZAWA, Tokyo (JP); Mitsuo KOUGO, Tokyo (JP); Masayoshi HIRANO, Tokyo (JP)

Correspondence Address: OLIFF & BERRIDGE, PLC, P.O. BOX 320850, ALEXANDRIA, VA, 22320-4850, US

(73) Assignee: TDK CORPORATION, Tokyo (JP)

(21) Appl. No.: 12/548,160

(22) Filed: Aug. 26, 2009

(30) Foreign Application Priority Data
Sep. 2, 2008 (JP) 2008-224899

(51) Int. Cl. H01M 4/62; H01M 4/04; H01G 9/058

(52) U.S. Cl. 429/209; 427/58; 174/126.2

(57) ABSTRACT

An electrode manufacturing method which can form a flat short-circuit prevention coating film (solid polyelectrolyte layer) having a uniform thickness and prevent short circuits from occurring in an electrochemical device is provided. The electrode manufacturing method comprises a first step of applying an active material layer coating material containing an active material particle, an active material layer binder, and a first solvent to a current collector so as to form a coating film made of the active material layer coating material; a second step of applying a second solvent to the coating film; and a third step of applying a solid polyelectrolyte layer coating material containing a solid polyelectrolyte, a solid polyelectrolyte layer binder, and a third solvent to the coating film coated with the second solvent. The first solvent is a good solvent for the active material layer binder, the second solvent is a poor solvent for the solid polyelectrolyte layer binder, and the third solvent is a good solvent for the solid polyelectrolyte layer binder.

### BACKGROUND OF THE INVENTION

1. Field of the Invention

The present invention relates to an electrode manufacturing method and an electrode.

2. Related Background Art

Electrochemical devices such as secondary batteries including lithium-ion secondary batteries and electrochemical capacitors including electric double layer capacitors are easy to reduce their size and weight, and thus are promising as power supplies or backup power supplies for portable devices (small-size electronic devices) and auxiliary power supplies for electric cars and hybrid cars, for example, whereby various studies have been under way in order to improve their safety.

In the electrochemical devices disclosed in Japanese Patent Application Laid-Open Nos. 10-106546, 11-185731, 11-288741, 2001-325951, and 2007-005323, the surface of an active material layer of a positive or negative electrode is covered with a coating film (hereinafter referred to as “short-circuit prevention coating film”) such as a porous film or ion-permeable resin in order to prevent the positive and negative electrodes from short-circuiting and secure safety.

### SUMMARY OF THE INVENTION

When the conventional electrochemical devices disclosed in the above-mentioned Patent Literatures 1 to 5 vibrate or their short-circuit prevention coating film shuts down at a high temperature, the short-circuit prevention coating film tends to peel off from the positive or negative electrode, shift from a predetermined position, or break, thereby letting the positive and negative electrodes to short-circuit.

The inventors have found that the above-mentioned short circuit is due to the fact that the short-circuit prevention coating film formed on the surface of the active material layer of the positive or negative electrode has a nonuniform thickness instead of being flat as in the following.

The conventional electrochemical devices disclosed in the above-mentioned Patent Literatures 1 to 5 form the short-circuit prevention coating film by coating the surface of the positive or negative active material layer with a coating material containing a constituent material of the short-circuit prevention coating film. Since a plurality of active material particles having various forms and sizes are arranged on the surface of the active material layer, the latter incurs irregularities. The coating material applied to such a surface of the active material layer covers the same in conformity to the irregularities, the resulting short-circuit prevention coating film tends to incur irregularities instead of becoming flat. The short-circuit prevention coating film tends to become thinner and thicker in protruded and recessed parts on the surface of the active material layer, respectively, thereby yielding a nonuniform thickness.

Such a nonflat short-circuit prevention coating film tends to peel off from the positive or negative electrode, shift from a predetermined position, or break because of a vibration or a shutdown at a high temperature, thereby causing a short circuit. Also, a dendrite is easier to form in the nonflat short-circuit prevention coating film, thereby causing a short circuit. These short circuits are more likely to occur when a plurality of positive or negative electrodes coated with the short-circuit prevention coating film are laminated.

In view of the problems of the prior art mentioned above, it is an object of the present invention to provide an electrode manufacturing method which can form a flat short-circuit prevention coating film having a uniform thickness and prevent short circuits from occurring in electrochemical devices, and an electrode which can prevent short circuits from occurring in electrochemical devices.

For achieving the above-mentioned object, the electrode manufacturing method in accordance with a first aspect of the present invention comprises a first step of applying an active material layer coating material containing an active material particle, an active material layer binder, and a first solvent to a current collector so as to form a coating film made of the active material layer coating material; a second step of applying a second solvent to the coating film; and a third step of applying a solid polyelectrolyte layer coating material containing a solid polyelectrolyte (hereinafter referred to as “SPE” as the case may be), a solid polyelectrolyte layer binder, and a third solvent to the coating film coated with the second solvent; wherein the first solvent is a good solvent for the active material layer binder; wherein the second solvent is a poor solvent for the solid polyelectrolyte layer binder; and wherein the third solvent is a good solvent for the solid polyelectrolyte layer binder.

In the present invention, the “good solvent for a binder” refers to a solvent which becomes exothermic by yielding negative heat of mixing when dissolving the binder, while the “poor solvent for a binder” refers to a solvent which becomes endothermic by yielding positive heat of mixing when dissolving the binder. In other words, the “good solvent for a binder” is a solvent which is easy to dissolve the binder, while the “poor solvent for a binder” is a solvent which is hard to dissolve the binder.

The first aspect of the present invention can form a flat solid polyelectrolyte layer (short-circuit prevention coating film) having a uniform thickness on the surface of the active material layer. Operations and advantageous effects of the first aspect of the present invention will be explained in detail in the following.

After applying the second solvent to the surface of a coating film which is a precursor of an active material layer, the first aspect of the present invention applies a solid polyelectrolyte layer coating material (SPE layer coating material) to the surface of the coating film, thereby forming a precursor (SPE layer precursor) of the solid polyelectrolyte layer (SPE layer). Removing the first, second, and third solvents yields an electrode comprising a current collector, an active material layer formed on the current collector, and an SPE layer formed on the active material layer.

Though the coating film surface tends to incur irregularities in conformity to forms of active material particles contained in the coating film, the first aspect of the present invention eliminates the irregularities on the coating film surface by covering the coating film with the second solvent. Applying the SPE layer coating material onto thus flattened coating film surface can form a flat SPE layer precursor having a uniform thickness. Hence, the SPE layer precursor can be inhibited from partly retracting into recesses of the coating film surface or projecting at protrusions of the coating film surface. Since the second solvent is a poor solvent for the SPE layer binder, the SPE layer precursor formed on the coating film surface covered with the second solvent is harder to be dissolved by the second solvent and can keep a flat form with a uniform thickness. That is, the SPE layer binder binding pieces of the SPE to each other in the SPE layer precursor is hard to be dissolved by the second solvent, whereby the SPE layer precursor keeps a flat form with a uniform thickness. Removing the solvent from within the SPE layer precursor thus kept in a flat form with a uniform thickness can yield a flat SPE layer with a uniform thickness. An electrochemical device using an electrode equipped with such a flat SPE layer with a uniform thickness can prevent short circuits from occurring between electrodes.

Since a wet SPE layer coating material is applied to the coating film surface kept in a wet (humid) state by the second solvent, the first aspect of the present invention improves the adhesion between the resulting active material layer and the SPE layer as compared with the case where the SPE layer coating material is applied to a dry (dried) coating film. A part of the SPE layer binder contained in the SPE layer coating material comes into contact with the second solvent (the poor solvent for the SPE layer binder) on the coating film surface, so as to be deposited between the SPE layer precursor and the coating film. Hence, on the SPE layer side of the active material layer in the resulting electrode, the SPE layer binder bonds the active material particles together and to the SPE layer, thereby improving the adhesion between the active material layer and the SPE layer. Thus improving the adhesion between the active material layer and the SPE layer can prevent the SPE layer from peeling and shifting, thereby avoiding short circuits in electrochemical devices.

In the first aspect of the present invention, the first solvent may be removed from the coating film before the second step. Removing the good solvent from the coating film allows the active material layer binder deposited within the coating film to bind pieces of the active material together. The advantageous effects of the present invention can also be attained when the second solvent is thus applied to the coating film after drying the coating film.

Preferably, in the first aspect of the present invention, the coating film coated with the second solvent is pressed before the third step. Pressing the coating film coated with the second solvent reduces the irregularities on the coating film surface, thereby making it easier to form a flat SPE layer precursor with a uniform thickness on the coating film surface.

Preferably, in the first aspect of the present invention, the second solvent is a poor solvent for the active material layer binder. In this case, the active material layer binder for binding the active material particles together within the coating film is hard to be dissolved by the second solvent, so that the coating film is more likely to keep its form, whereby a flat active material layer having a uniform thickness is obtained more easily, while the advantageous effects of the present invention are easier to attain.

Preferably, in the first aspect of the present invention, the solid polyelectrolyte layer binder is polyvinylidene fluoride, while the second solvent is at least one species selected from the group consisting of water, hexane, toluene, xylene, and alcohol.

Employing the combination of the SPE layer binder and second solvent mentioned above makes it easier to attain the advantageous effects of the first aspect of the present invention.

The electrode manufacturing method in accordance with a second aspect of the present invention comprises the steps of applying an active material layer coating material containing an active material particle, an active material layer binder, and a first solvent to a current collector so as to form a coating film made of the active material layer coating material; and applying a solid polyelectrolyte layer coating material containing a solid polyelectrolyte, a solid polyelectrolyte layer binder, and a third solvent to the coating film; wherein the first solvent is a good solvent for the active material layer binder and a poor solvent for the solid polyelectrolyte layer binder; and wherein the third solvent is a good solvent for the solid polyelectrolyte layer binder.

As with the first aspect of the present invention, the second aspect of the present invention can form a flat solid polyelectrolyte layer (short-circuit prevention coating film) having a uniform thickness on the surface of the active material layer.

The second aspect of the present invention applies a solid polyelectrolyte layer coating material (SPE layer coating material) to the surface of a coating film which is a precursor of an active material layer, thereby forming a precursor (SPE layer precursor) of the solid polyelectrolyte layer (SPE layer). Removing the first and third solvents yields an electrode comprising a current collector, an active material layer formed on the current collector, and an SPE layer formed on the active material layer.

In the second aspect of the present invention, the first solvent wetting the coating film mitigates the irregularities on the surface of the coating film. Applying the SPE layer coating material to the coating film surface thus having mitigated irregularities can form a flat SPE layer precursor with a uniform thickness. Hence, the SPE layer precursor can be inhibited from partly retracting into recesses of the coating film surface or projecting at protrusions of the coating film surface. Since the first solvent is a poor solvent for the SPE layer binder, the SPE layer precursor formed on the coating film surface is harder to be dissolved by the first solvent and can keep a flat form with a uniform thickness. That is, the SPE layer binder binding pieces of the SPE to each other in the SPE layer precursor is hard to be dissolved by the first solvent, whereby the SPE layer precursor keeps a flat form with a uniform thickness. Removing the solvent from within the SPE layer precursor thus kept in a flat form with a uniform thickness can yield a flat SPE layer with a uniform thickness. An electrochemical device using an electrode equipped with such a flat SPE layer with a uniform thickness can prevent short circuits from occurring between electrodes.

Since a wet SPE layer coating material is applied to the coating film surface kept in a wet (humid) state by the first solvent, the second aspect of the present invention improves the adhesion between the resulting active material layer and the SPE layer as compared with the case where the SPE layer coating material is applied to a dry (dried) coating film. A part of the SPE layer binder contained in the SPE layer coating material comes into contact with the first solvent (the poor solvent for the SPE layer binder) on the coating film surface, so as to be deposited between the SPE layer precursor and the coating film. Hence, on the SPE layer side of the active material layer in the resulting electrode, the SPE layer bonds the active material particles together and to the SPE layer, thereby improving the adhesion between the active material layer and the SPE layer. Thus improving the adhesion between the active material layer and the SPE layer can prevent the SPE layer from peeling and shifting, thereby avoiding short circuits in electrochemical devices.

Preferably, in the second aspect of the present invention, the active material layer binder contains styrene-butadiene rubber and carboxymethyl cellulose, the solid polyelectrolyte layer binder contains at least one of polyvinylidene fluoride and polyethylene oxide, and the first solvent contains water and alcohol.

Employing the combination of the active material layer binder, SPE layer binder, and first solvent mentioned above makes it easier to attain the advantageous effects of the second aspect of the present invention.

Preferably, in the first and second aspects of the present invention, the solid polyelectrolyte contains at least one of polyvinylidene fluoride and polyethylene oxide. This makes it easier to attain the advantageous effects of the present invention.

The electrode in accordance with the present invention comprises a current collector; an active material layer, formed on the current collector, containing an active material particle and an active material layer binder; and a solid polyelectrolyte layer, formed on the active material layer, containing a solid polyelectrolyte and a solid polyelectrolyte layer binder; wherein an interstice between a plurality of active material particles positioned on a surface of the active material layer facing the solid polyelectrolyte layer is filled with the solid polyelectrolyte layer binder.

Since the interstice between a plurality of active material particles positioned on a surface of the active material layer facing the solid polyelectrolyte layer is filled with the solid polyelectrolyte layer binder, the SPE layer formed on the surface of the active material layer is kept in a flat form with a uniform thickness in the electrode in accordance with the present invention. The electrochemical device equipped with such an electrode avoids short circuits between electrodes.

Preferably, in the electrode in accordance with the present invention, the surface of the active material layer facing the solid polyelectrolyte layer, constituted by the plurality of active material particles and the solid polyelectrolyte layer binder filling the interstice between the plurality of active material particles, is substantially parallel to a surface of the solid polyelectrolyte layer opposite from the active material layer. The SPE layer formed on the surface of the active material layer is likely to keep a flat form with a uniform thickness in such an electrode, while an electrochemical device equipped with such an electrode is easy to avoid short circuits between electrodes.

Preferably, in the electrode in accordance with the present invention, the active material particle is constituted by a negative electrode active material. Hence, the electrode in accordance with the present invention is suitable as a negative electrode for an electrochemical device. In the negative electrode of the electrochemical device, as compared with the positive electrode, a dendrite is more likely to form and, in particular, a recess or protrusion on a surface of the SPE layer covering the negative electrode active material layer is more likely to become a start point for the dendrite. The dendrite formed at the negative electrode tends to cause short circuits. Therefore, using the electrode in accordance with the present invention equipped with a flat SPE layer on the surface of the negative electrode active material layer as a negative electrode makes it easier to inhibit the dendrite from being formed and avoid short circuits.

Preferably, in the present invention, the solid polyelectrolyte layer has a thickness of 5 to 30 μm.

When the SPE layer is too thin, the effect of avoiding short circuits tends to become smaller. When the SPE layer is too thick, the resistance to ion diffusion in the SPE layer tends to become greater, thereby increasing impedance in the electrochemical device. The SPE layer having a thickness falling within the range mentioned above can suppress these tendencies.

The present invention can provide an electrode manufacturing method which can form a flat short-circuit prevention coating film (solid polyelectrolyte layer) having a uniform thickness and prevent short circuits from occurring in electrochemical devices, and an electrode which can prevent short circuits from occurring in electrochemical devices.

### BRIEF DESCRIPTION OF THE DRAWINGS

FIG. 1 is a schematic sectional view of a current collector and a coating film made of an active material layer coating material applied onto the current collector, illustrating a first step in the electrode manufacturing method in accordance with a first embodiment of the present invention.

FIG. 2 is a schematic sectional view of the coating film having removed a first solvent, illustrating a step of removing the first solvent in the electrode manufacturing method in accordance with the first embodiment of the present invention.

FIG. 3 is a schematic sectional view of the current collector, the coating film coated with the first solvent, and a calender roll for pressing the SPE layer precursor, illustrating a second step in the electrode manufacturing method in accordance with the first embodiment of the present invention.

FIG. 4 is a schematic sectional view of the current collector, the coating film coated with a second solvent, an SPE layer precursor formed on the coating film, and a calender roll for pressing the coating film, illustrating a third step in the electrode manufacturing method in accordance with the first embodiment of the present invention.

FIG. 5 is a schematic sectional view of an electrode obtained by the electrode manufacturing method in accordance with the first embodiment of the present invention.

FIG. 6 is a schematic sectional view of a current collector, a coating film made of an active material layer coating material, an SPE layer precursor formed on the coating film, and a calender roll for pressing the SPE layer precursor, illustrating the electrode manufacturing method in accordance with a second embodiment of the present invention.

FIG. 7 is an SEM image of a cross section of a negative electrode in Example 1.

FIG. 8 is an SEM image of a cross section of a negative electrode in Comparative Example 1.

### REFERENCE SIGNS LIST

2 . . . active material particle; 4 . . . first solvent; 6 . . . current collector; 8a, 8b, 8c . . . coating film; 8d . . . active material layer; 10 . . . second solvent; 12 . . . calender roll; 14a . . . solid polyelectrolyte layer precursor; 14b . . . solid polyelectrolyte layer; 16 . . . solid polyelectrolyte layer binder; 100 . . . electrode

### DESCRIPTION OF THE PREFERRED EMBODIMENTS

In the following, as preferred embodiments of the electrode manufacturing method in accordance with the present invention, a method of manufacturing an electrode used in a lithium-ion secondary battery and the electrode obtained by this method will be explained in detail with reference to the drawings. Though the lithium-ion secondary battery comprises positive and negative electrodes as electrodes, the following will explain a manufacturing method common in both positive and negative electrodes without distinguishing them from each other except for respective materials used for manufacturing the positive and negative electrodes. In the drawings, the same or equivalent parts will be referred to with the same signs while omitting their overlapping explanations. Positional relationships such as upper, lower, left, and right will be based on positional relationships represented in the drawings unless otherwise specified. Ratios of dimensions in the drawings are not limited to those depicted.

### First Embodiment

### Electrode Manufacturing Method

The electrode manufacturing method in accordance with the first embodiment comprises a step (first step: S1) of applying an active material layer coating material containing active material particles, an active material layer binder, and a first solvent to a current collector so as to form a coating film made of the active material layer coating material; a step (first solvent removing step: S2) of removing the first solvent from the coating film; a step (second step: S3) of applying a second solvent to the coating film having removed the first solvent; a step (third step: S4) of applying an SPE layer coating material containing a solid polyelectrolyte (SPE), an SPE layer binder, and a third solvent to the coating film coated with the second solvent; and a step (solvent removing step: S5) of removing the second and third solvents from the coating film and the SPE layer precursor.

The first solvent is a good solvent for the active material layer binder, the second solvent is a poor solvent for the SPE layer binder, and the third solvent is a good solvent for the SPE layer binder.

First Step: S1

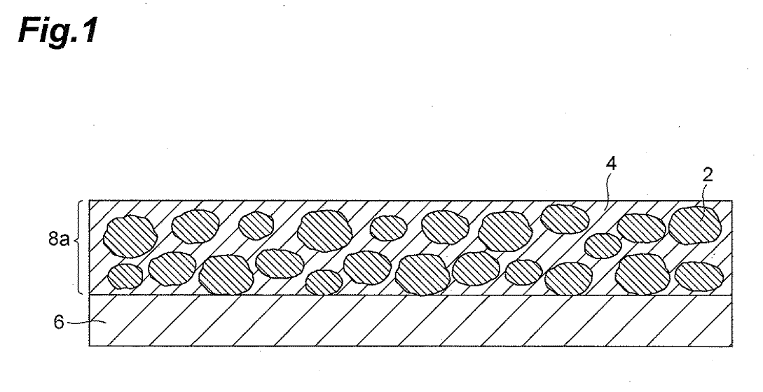

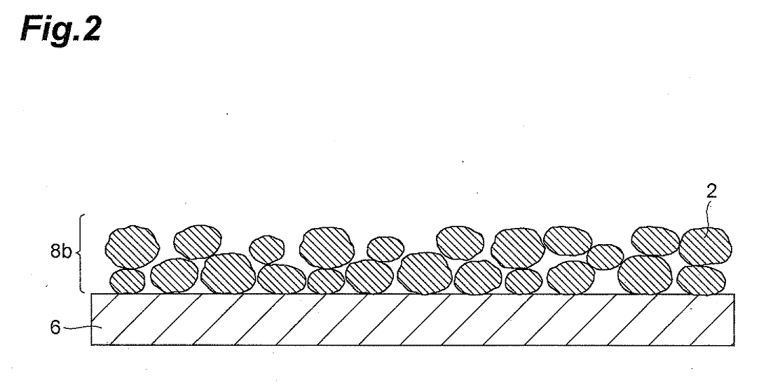

In the first step, an active material layer coating material in which active material particles, an active material layer binder, and a conductive auxiliary are dispersed in the first solvent is initially prepared. Subsequently, as illustrated in FIG. 1, the active material layer coating material is applied to a surface of a current collector 6, so as to form a coating film 8a made of the active material layer coating material. For simplification, FIG. 1 illustrates only the active material particles 2 and first solvent 4 among the substances contained in the coating film 8a, while omitting the conductive auxiliary and the active material layer binder dissolved in the first solvent 4. FIGS. 2 to 5 also omit the conductive auxiliary and active material layer binder for the same reason.

For manufacturing positive and negative electrodes as the electrode, it will be sufficient if the coating material contains the active material particles 2 constituted by positive and negative electrode active materials, respectively.

The positive electrode active material is not limited in particular as long as it allows occlusion and release of lithium ions, desorption and insertion (intercalation) of lithium ions, or doping and undoping of lithium ions and their counter anions (e.g., PF₆⁻) to proceed reversibly. Its usable examples include lithium cobaltate (LiCoO₂), lithium nickelate (LiNiO₂), lithium manganese spinel (LiMn₂O₄), mixed metal oxides expressed by the general formula of LiNiₓCo_{y}Mn_{z}MₐO₂ (where x+y+z+a=1, 0≦x≦1, 0≦y≦1, 0≦z≦1, 0≦a≦1, and M is at least one kind of element selected from Al, Mg, Nb, Ti, Cu, Zn, and Cr), a lithium vanadium compound (LiV₂O₅), olivine-type LiMPO₄ (where M is at least one kind of element selected from Co, Ni, Mn or Fe, Mg, Nb, Ti, Al, and Zr, or VO), and lithium titanate (Li₄Ti₅O₁₂).

The negative electrode active material is not limited in particular as long as it allows occlusion and release of lithium ions, desorption and insertion (intercalation) of lithium ions, or doping and undoping of lithium ions and their counter anions (e.g., PF₆⁻) to proceed reversibly. Its usable examples include carbon materials such as natural graphite, synthetic graphite, non-graphitizing carbon, graphitizable carbon, and low-temperature-firable carbon; metals such as Al, Si, and Sn which are combinable with lithium; amorphous compounds mainly composed of oxides such as SiOₓ (where 1<x≦2) and SnOₓ(where 1<x≦2); lithium titanate (Li₄Ti₅O₁₂); and TiO₂.

Usable examples of the active material layer binder include polyvinylidene fluoride (PVDF), polytetrafluoroethylene (PTFE), carboxymethyl cellulose (CMC), and styrene-butadiene rubber (SBR). Also employable as the binder are fluororesins/fluorine rubbers (hereinafter referred to as “VDF copolymers”) such as fluorine rubbers based on vinylidene fluoride/hexafluoropropylene (VDF/HFP-based fluorine rubbers) and those based on vinylidene fluoride/hexafluoropropylene/tetrafluoroethylene (VDF/HFP/TFE-based fluorine rubbers). CMC and SBS may be used in combination.

As the first solvent 4, one conforming to the active material layer binder in use is selectively employed as appropriate. When PVDF is used as the binder, N-methylpyrrolidone (NMP) is employed alone or in combination with others as the first solvent 4. When CMC or SBR is used as the binder, water and alcohols (methanol, ethanol, propanol, butanol, etc.) are employed singly or in combination as the first solvent 4. When a VDF copolymer is used as the binder, acetone is employed alone or in combination with others as the first solvent 4. When PTFE is used as the active material layer binder, PTFE can be used alone as it is without adding solvents other than PTFE to the active material layer coating material. Hence, PTFE serves as both the active material layer binder and the first solvent 4 for preparing the active material layer coating material.

The conductive auxiliary is not restricted in particular. Its usable examples include carbon blacks; carbon materials; powders of metals such as copper, nickel, stainless steel, and iron; mixtures of carbon materials and powders of metals; and conductive oxides such as ITO.

As the current collector 6, it will be sufficient if a good conductor which fully allows electric charges to migrate to the active material layer is used; its usable examples include foils of metals such as copper and aluminum. It will be preferred in particular if one which does not form any alloy with lithium is used as the current collector for the negative electrode, while one which does not corrode is used as the current collector for the positive electrode.

First Solvent Removing Step: S2

In the step of removing the first solvent 4, the coating film 8a is dried, so as to remove the first solvent 4 from the coating film 8a. As a consequence, the active material layer binder dissolved in the first solvent 4 is deposited between the active material particles 2, between pieces of the conductive auxiliary, and between the active material particle 2 and the conductive auxiliary. This yields a coating film 8b made of the active material particles 2 and conductive auxiliary bound together by the binder as illustrated in FIG. 2.

Second Step: S3

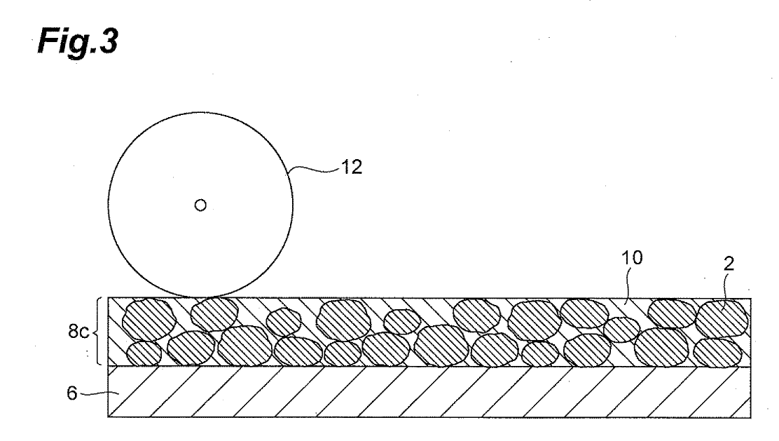

In the second step, as illustrated in FIG. 3, a second solvent 10 is applied to the coating film 8b having removed the first solvent 4, so as to infiltrate into interstices (between the active material particles 2 and conductive auxiliary) in the coating film 8b, thereby forming a coating film 8c. While the surface of the coating film 8b tends to incur irregularities in conformity to the forms of the active material particles 2 contained in the coating film 8b as illustrated in FIG. 2, the irregularities are eliminated on the surface of the coating film 8c formed by covering the coating film 8b with the second solvent 10 as illustrated in FIG. 3.

When applying the second solvent 10 to the coating film 8b having removed the first solvent 4, it will be preferred if the surface of the coating film 8b is covered with the second solvent 10. In other words, the coating film 8b is preferably coated with the second solvent 10 by such an amount that the solid part (constituted by the active material particles 2 and conductive auxiliary) is fully immersed in the second solvent 10 in the coating film 8c after being coated with the second solvent 10. This makes it easier for the second solvent 10 to infiltrate throughout the coating film 8c and eliminate the irregularities on the surface of the coating film 8c, whereby the advantageous effects of the present invention are obtained more easily.

As the second solvent 10, a poor solvent for the SPE layer binder is selectively used in conformity to the SPE layer binder as appropriate. When PVDF or PTFE is used as the SPE layer binder, water, acetone, methylethylketone (MEK), hexane, toluene, xylene, and alcohols (methanol, ethanol, propanol, butanol, etc.) are employed singly or in combination as the second solvent 10. When a VDF copolymer is used as the SPE layer binder, water, hexane, toluene, xylene, and alcohols (methanol, ethanol, propanol, butanol, etc.) are employed singly or in combination as the second solvent 10. When CMC or SBR is used as the SPE layer binder, acetone, MEK, hexane, toluene, and xylene are employed singly or in combination as the second solvent 10.

Preferably, the second solvent 10 is a poor solvent not only for the SPE layer binder but also for the active material layer binder. In this case, the second solvent 10 hardly dissolves the active material layer binder binding the active material particles 2 and conductive auxiliary. Therefore, in the coating film 8c coated with the second solvent 10, the active material particles 2 and the conductive auxiliary are kept in a mutually bound state by the active material layer binder, so that the form of the coating film 8c is easier to keep, whereby a flat active material layer having a uniform thickness is obtained more easily, while a flat SPE layer precursor having a uniform thickness is easier to form in the third step that will be explained later.

In this embodiment, the whole surface of the coating film 8c coated with the second solvent 10 is pressed (roll-processed) by a calender roll 12. Hence, the coating film 8c in a wet state is pressed. This makes it easier to eliminate the irregularities on the surface of the coating film 8c, whereby a flat SPE layer precursor having a uniform thickness is easier to form on the surface of the coating film 8c in the following third step.

The coating film 8c may be pressed while the surface of the calender roll or the coating film 8c is heated. This makes it further easier to eliminate the irregularities on the surface of the coating film 8c.

Third Step: S4

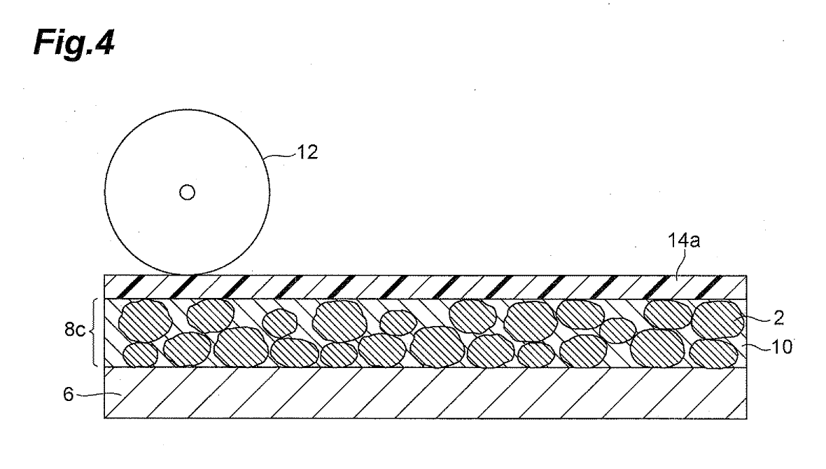

In the third step, as illustrated in FIG. 4, the SPE layer coating material is applied to the coating film 8c coated with the second solvent 10, so as to form an SPE layer precursor 14a, which is then pressed (roll-processed) by the calender roll 12. The coated SPE layer precursor 14a may be pressed while the surface of the calender roll or the SPE layer coating material applied to the coating film 8c is heated.

Usable examples of the solid polyelectrolyte (SPE) contained in the SPE layer coating material include PVDF (homopolymer), VDF copolymers, fluorine rubbers, and polyethylene oxide (PEO), among which a VDF copolymer or PEO is preferably used. This makes it easier to achieve the advantageous effects of the present invention.

Usable examples of the SPE layer binder include polyvinylidene fluoride (PVDF), polytetrafluoroethylene (PTFE), carboxymethyl cellulose (CMC), and styrene-butadiene rubber (SBR). Also employable as the binder are fluororesins/fluorine rubbers such as fluorine rubbers based on vinylidene fluoride/hexafluoropropylene (VDF/HFP-based fluorine rubbers) and those based on vinylidene fluoride/hexafluoropropylene/tetrafluoroethylene (VDF/HFP/TFE-based fluorine rubbers). CMC and SBS may be used in combination. Preferably, the SPE layer binder is a material different from the active material layer binder. This can clearly form an interface between the coating film 8c and the SPE layer precursor 14a (the boundary face between the active material layer and the SPE layer), so as to prevent the coating film 8c from being exposed in the subsequent step of pressing (roll-processing) the SPE layer precursor 14a, thereby keeping short circuits from occurring in an electrochemical device equipped with the resulting electrode.

As the third solvent, a good solvent for the SPE layer binder is selectively used in conformity to the SPE layer binder in use as appropriate. When PVDF is used as the binder, NMP is employed alone or in combination with others as the third solvent. When CMC or SBR is used as the binder, water and alcohols (methanol, ethanol, propanol, butanol, etc.) are employed singly or in combination as the third solvent. When a VDF copolymer is used as the binder, acetone is employed alone or in combination with others as the third solvent. When PTFE is used as the SPE layer binder, PTFE can be employed alone as it is without adding solvents other than PTFE to the SPE layer coating material. Hence, PTFE serves as both the SPE layer binder and the third solvent for preparing the SPE layer coating material.

Preferably, the SPE layer binder is polyvinylidene fluoride, while the second solvent is at least one species selected from the group consisting of water, hexane, toluene, xylene, and alcohol. Employing such a combination of the SPE layer binder and second solvent makes it easier to attain the advantageous effects of the present invention.

Solvent Removing Step: S5

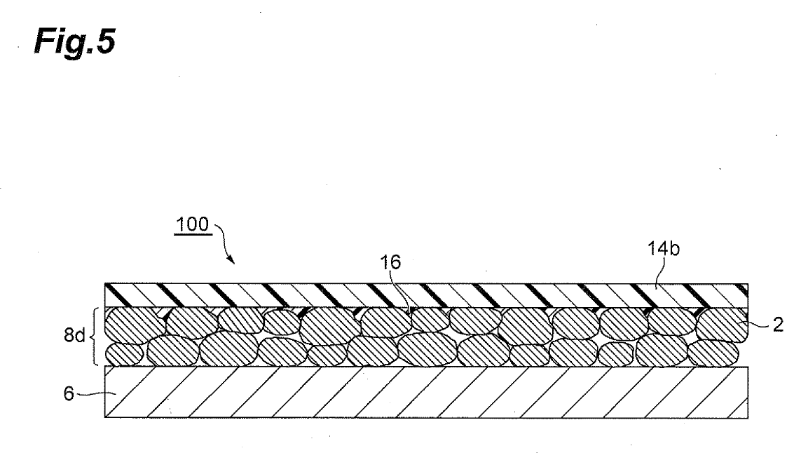

In the solvent removing step, the coating film 8c on the current collector and the SPE layer precursor 14a on the coating film 8c are dried, so as to remove the second solvent 10 and third solvent from the coating film 8c and SPE layer precursor 14a. This yields an electrode 100 comprising the current collector 6, an active material layer 8d formed on the current collector 6, and an SPE layer 14b formed on the active material layer 8d as illustrated in FIG. 5.

By applying the SPE layer coating material to the flattened surface of the coating film 8c in the third step, the first embodiment can form the flat SPE layer precursor 14a having a uniform thickness as illustrated in FIG. 4. Hence, the SPE layer precursor 14a can be inhibited from partly retracting into recesses (between the active material particles 2 and conductive auxiliary) on the surface of the coating film 8c or projecting at protrusions on the surface of the coating film 8c. Since the second solvent 10 is a poor solvent for the SPE layer binder, the SPE layer precursor 14a is harder to be dissolved by the second solvent 10 and can keep a flat form with a uniform thickness. Drying the SPE layer precursor 14 kept in a flat form with a uniform thickness can yield the flat SPE layer 14b with a uniform thickness as illustrated in FIG. 5. A lithium-ion secondary battery using the electrode 100 equipped with such flat SPE layer 14b with a uniform thickness can prevent short circuits from occurring between electrodes.

As illustrated in FIG. 4, since a wet SPE layer coating material is applied to the surface of the coating film 8c kept in a wet (humid) state by the second solvent 10, the first embodiment improves the adhesion between the resulting active material layer 8d and the SPE layer 14b as compared with the case where the SPE layer coating material is applied to a dry (dried) coating film. A part of the SPE layer binder contained in the SPE layer coating material comes into contact with the second solvent 10 (the poor solvent for the SPE layer binder) on the surface of the coating film 8c, so as to be deposited between the SPE layer precursor 14a and the coating film 8c. As a result, on the SPE layer 14b side of the active material layer 8d in the resulting electrode, the SPE layer binder bonds the active material particles 2, the conductive auxiliary, and the SPE layer 14b together, thereby improving the adhesion between the active material layer 8d and the SPE layer 14b. Thus improving the adhesion between the active material layer 8d and the SPE layer 14b can prevent the SPE layer 14b from peeling and shifting, thereby avoiding short circuits in the lithium-ion secondary battery.

Since the SPE layer coating material is applied to the surface of the coating film 8c coated with the second solvent 10 in the third step, the SPE layer coating material is kept from partly retracting into recesses (between the active material particles 2 and conductive auxiliary) on the surface of the coating film 8c in the first embodiment. That is, voids formed on the surface of the resulting active material layer 8d are not clogged with a part of the SPE layer 8d. This can prevent ion diffusion resistance from being enhanced by the clogging of the voids with the SPE layer 8d. If the surface of the coating film 8b not coated with the second solvent 10 is to be coated with the SPE layer coating material, it will be necessary for the SPE layer coating material to be provided with a desirable viscosity in order to prevent the SPE layer coating material from infiltrating into the recesses on the surface of the coating film 8b, which limits the selection of materials for the SPE layer coating material. The first embodiment eliminates such limitation.

Since the SPE layer coating material is kept from partly retracting into recesses on the surface of the coating film 8c in the third step, adjusting the amount of the SPE layer coating material to be applied to the coating film 8c in the first embodiment makes it easier to control the thickness of the resulting SPE layer 14b and can form the SPE layer 14b thinner.

When pressing the coating film 8c coated with the second solvent 10 prior to the third step, the second solvent 10 having infiltrated into interstices (between the active material particles 2 and conductive auxiliary) in the coating film 8c serves as a buffer, thereby making it harder for excessive pressures to act on the active material particles 2 and conductive auxiliary and easier for pressures to transmit through the second solvent 10 to the whole coating film 8c. This can form the active material layer 8d having a uniform thickness with a uniformly porous surface.

More specifically, when the coating film 8c coated with the second solvent 10 is pressed, the second solvent 10 covering the surface of the coating film 8c acts as a buffer, whereby the calender roll 12 can be inhibited from excessively compacting or collapsing the active material particles 2 and conductive auxiliary on the surface of the coating film 8c. As a result, the density of the active material layer 8d on the SPE layer 14b side and the ion diffusion resistance in the active material layer 8d become lower than those in electrodes obtained by the conventional manufacturing methods.

On the current collector 6 side of the coating film 8c, pressures are easier to act through the second solvent 10 having infiltrated into interstices (between the active material particles 2 and conductive auxiliary) in the coating film 8c, thereby appropriately compressing the active material particles 2 and conductive auxiliary. This enhances the density of the active material layer 8d on the current collector 6 side and improves the electric conductivity of the resulting electrode 100 as compared with electrodes obtained by the conventional manufacturing methods.

Because of the foregoing, a lithium-ion secondary battery equipped with the electrode 100 obtained by the electrode manufacturing method in accordance with the first embodiment lowers its impedance and improves its output and capacity as compared with lithium-ion secondary batteries equipped with electrodes obtained by the conventional manufacturing methods.

The electrode manufacturing method in accordance with the first embodiment is suitable as a method of manufacturing an electrode for a battery having a large capacity of 2 Ah or more or an electrode having a large area of 100 mm×100 mm or more.

Electrode 100

As illustrated in FIG. 5, the electrode 100 obtained by the above-mentioned electrode manufacturing method in accordance with the first embodiment comprises the current collector 6; the active material layer 8d, formed on the current collector 6, containing the active material particles 2, the conductive auxiliary, and the active material layer binder; and the SPE layer 14b, formed on the active material layer 8d, containing the SPE and the SPE layer binder; while the interstices between a plurality of active material particles 2 positioned on the surface of the active material layer 8d on the SPE Layer 14b side and the conductive auxiliary are filled with the SPE layer binder 16. The SPE layer binder is a material different from the active material layer binder. A first layer constituted by a plurality of active material particles 2, the conductive auxiliary, and the SPE layer binder 16 filling the interstices therebetween and a second layer positioned closer to the current collector 6 than is the first layer and constituted by a plurality of active material particles 2, the conductive auxiliary, the SPE layer binder 16 and active material layer binder filling the interstices therebetween seem to be formed in the vicinity of the interface between the active material particle 8d and the SPE layer 14b.

Since the interstices between a plurality of active material particles 2 positioned on the surface of the active material layer 8d on the SPE layer 14b side and the conductive auxiliary are filled with the SPE layer binder 16, the SPE layer 14b formed on the surface of the active material layer 8d is kept in a flat form with a uniform thickness in the electrode 100. The lithium-ion secondary battery equipped with such electrode 100 prevents short circuits from occurring between electrodes.

In the electrode 100, the surface on the SPE layer 14b side of the active material layer 8d constituted by a plurality of active material particles 2, the conductive auxiliary, and the SPE layer binder 16 filling the interstices therebetween is parallel to the surface of the SPE layer 14b opposite from the active material layer 8d. In such electrode 100, the SPE layer 14b formed on the surface of the active material layer 8d is easier to keep a flat form with a uniform thickness, whereby a lithium-ion secondary battery equipped with such electrode 100 is easier to prevent short circuits from occurring between electrodes.

Preferably, in the electrode 100, the active material particles 2 are constituted by a negative electrode active material. Hence, the electrode 100 is suitable as a negative electrode for a lithium-ion secondary battery. In the negative electrode of the lithium-ion secondary battery, as compared with the positive electrode, a dendrite is more likely to form and, in particular, a recess or protrusion on a surface of the SPE layer covering the negative electrode active material layer is more likely to become a start point for the dendrite. The dendrite formed at the negative electrode tends to cause short circuits. Therefore, using the electrode 100 equipped with the flat SPE layer 14b on the surface of the negative electrode active material layer as a negative electrode makes it easier to inhibit the dendrite from being formed and avoid short circuits.

Preferably, the SPE layer 14b has an average thickness of 5 to 30 μm.

When the SPE layer 14b is too thin, the effect of avoiding short circuits tends to become smaller. When the SPE layer 14b is too thick, the resistance to ion diffusion in the SPE layer 14b tends to become greater, thereby increasing impedance in the lithium-ion secondary battery. The SPE layer 14b having a thickness falling within the range mentioned above can suppress these tendencies.

Lithium-Ion Secondary Battery

When making a lithium-ion secondary battery by using electrodes 100 (negative and positive electrodes) obtained by the manufacturing method in accordance with the first embodiment, negative and positive electrode leads are electrically connected to the negative and positive electrodes, respectively, at first. Subsequently, a separator is arranged between the negative and positive electrodes such as to be in contact therewith, thus forming a power generating element. Here, the negative and positive electrodes are arranged such that their surfaces on the SPE layer 14b side are in contact with the separator.

Next, the power generating element is inserted into a case having an opening, and an electrolytic solution is further injected therein. Subsequently, in a state where respective portions of negative and positive electrode leads are inserted into the case while the remaining portions are arranged on the outside of the case, the opening of the case is sealed, whereby a lithium-ion secondary battery is completed.

The respective SPE layers 14b, 14b of the negative and positive electrodes serve as separators and thus may be brought into contact with each other without interposing a separator between the negative and positive electrodes.

### Second Embodiment

The electrode manufacturing method in accordance with the second embodiment of the present invention will now be explained. Here, while omitting matters common in the first and second embodiments, only their differences will be explained.

Unlike the first embodiment, the second embodiment does not use the second solvent. The first solvent 4 is a good solvent for the active material layer binder and a poor solvent for the SPE layer binder, while the third solvent is a good solvent for the SPE layer binder.

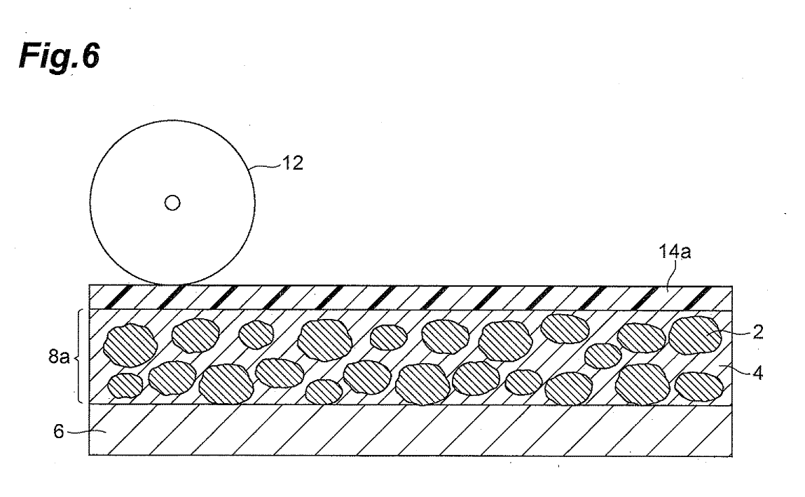

As illustrated in FIG. 6, the electrode manufacturing method in accordance with the second embodiment applies an active material layer coating material containing active material particles 2, an active material layer binder, and the first solvent 4 to a current collector 6, so as to form a coating film 8a (active material layer precursor) made of the active material layer coating material.

Next, an SPE layer coating material containing an SPE, an SPE layer binder, and the third solvent is applied to the coating film 8a, so as to form an SPE layer precursor 14a, which is then pressed by a calender roll 12.

After forming the SPE layer precursor 14a, the first solvent 4 and the third solvent are removed from the coating film 8a and SPE layer precursor 14a by drying, whereby the electrode 100 illustrated in FIG. 5 is obtained as in the first embodiment. Thus, the electrode manufacturing method in accordance with the second embodiment can form a flat SPE layer 14b having a uniform thickness on the surface of the active material layer 8d as in the first embodiment.

In the second embodiment, the first solvent 4 wetting the coating film 8a mitigates the irregularities on the surface of the coating film 8a. Applying the SPE layer coating material to the surface of the coating film 8a thus having mitigated irregularities can form the flat SPE layer precursor 14a with a uniform thickness. Since the first solvent 4 is a poor solvent for the SPE layer binder, the SPE layer binder binding pieces of the SPE to each other in the SPE layer precursor 14a is hard to be dissolved by the first solvent 4, whereby the SPE layer precursor 14a keeps a flat form with a uniform thickness. Removing the solvent from within the SPE layer precursor 14a thus kept in a flat form with a uniform thickness can yield a flat SPE layer 14b with a uniform thickness as illustrated in FIG. 5.

Since a wet SPE layer coating material is applied to the surface of the coating film 8a kept in a wet (humid) state by the first solvent 4, the second embodiment improves the adhesion between the resulting active material layer 8d and the SPE layer 14b as compared with the case where the SPE layer coating material is applied to a dry (dried) coating film. A part of the SPE layer binder contained in the SPE layer coating material comes into contact with the first solvent 4 (the poor solvent for the SPE layer binder) on the surface of the coating film 8a, so as to be deposited between the SPE layer precursor 14a and the coating film 8a. Hence, on the SPE layer 14b side of the active material layer 8d in the resulting electrode 100, the SPE layer binder bonds the active material particles 2, the conductive auxiliary, and the SPE layer 14b together, thereby improving the adhesion between the active material layer 8d and the SPE layer 14b. Thus improving the adhesion between the active material layer 8d and the SPE layer 14b can prevent the SPE layer 14b from peeling and shifting, thereby avoiding short circuits in the lithium-ion secondary battery.

Preferably, in the second embodiment, the active material layer binder is constituted by styrene-butadiene rubber (SBR) and carboxymethyl cellulose (CMC), the SPE layer binder is PVDF (homopolymer), a VDF copolymer, or PEO, and the first solvent is constituted by water and alcohol. When the SPE layer binder is PVDF (homopolymer), the third solvent is preferably NMP. When the SPE layer binder is a VDF copolymer or PEO, the third solvent is preferably acetone.

Employing the combination of the active material layer binder, SPE layer binder, first solvent, and third solvent mentioned above makes it easier to attain the advantageous effects of the present invention.

Though the preferred first and second embodiments of the present invention are explained in detail in the foregoing, the present invention is not limited to the above-mentioned embodiments.

For example, the second solvent may directly be applied to the coating film containing the first solvent in the first embodiment without carrying out the first solvent removing step. Hence, after directly applying the second solvent to the coating film made of the active material layer coating material and then applying the SPE layer coating material to the coating film coated with the second solvent, the first, second, and third solvents may be removed together from the coating film and SPE layer precursor by drying. As a consequence, the forming of the coating film, the coating with the second solvent, and the coating with the SPE layer coating material can be carried out continuously without interposing the steps of removing the solvents.

The first embodiment may refrain from pressing the coating film 8c coated with the second solvent 10 prior to the third step. The advantageous effects of the present invention can also be obtained in this case.

Though the above-mentioned embodiments explain the case where the electrochemical device is a lithium-ion secondary battery, the electrochemical device is not limited to the lithium-ion secondary battery, but may be secondary batteries other than the lithium-ion secondary battery, such as metal lithium secondary batteries, and electrochemical capacitors such as lithium capacitors. The electrochemical device equipped with the electrode obtained by the manufacturing method of the present invention can also be used in power supplies for self-propelled micromachines and IC cards, and decentralized power supplies placed on or within printed boards.

The present invention will now be explained more specifically with reference to an example and a comparative example, which do not restrict the present invention.

### Example 1

### Making of Active Material Layer Coating Material

Active material particles made of graphite (product name: OMAC, manufactured by Osaka Gas Chemicals Co. Ltd.), PVDF (homopolymer; product name: 761, manufactured by Atofina) as an active material layer binder, and carbon black (product name: DAB, manufactured by Denki Kagaku Kogyo K.K.) as a conductive auxiliary were dispersed into NMP, which was a good solvent (first solvent) for the active material layer, so as to prepare a negative electrode coating material.

Making of SPE Layer Coating Material

A VDF copolymer (copolymer of vinyl fluoride and propylene hexafluoride; product name: 2801, manufactured by Atofina), which was a solid polyelectrolyte, and a VDF copolymer (copolymer of vinyl fluoride and propylene hexafluoride; product name: 2801, manufactured by Atofina), which was an SPE layer binder, were dispersed into acetone, which was a good solvent (third solvent) for the SPE layer binder, so as to prepare an SPE layer coating material.

Making of Negative Electrode

First Step: S1

In the coating film forming step, the active material layer coating material was applied to a surface of a Cu foil (current collector), so as to form a coating film made of the active material layer coating material.

First Solvent Removing Step: S2

In the first solvent removing step, the coating film was dried in a drying furnace, so as to remove NMP (the first solvent) from the coating film.

Second Step: S3

In the second step, the whole surface of the coating film (hereinafter referred to as “dry coating film”) having removed NMP (the first solvent) was coated with xylene as the second solvent, which was a poor solvent for the SPE layer binder, and then the whole surface of the coating film was pressed by a calender roll.

Third Step: S4

In the third step, the pressed coating film was coated with the SPE layer coating material, so as to form an SPE layer precursor made of the SPE layer coating material, which was then pressed (roll-processed) by the calender roll.

Solvent Removing Step: S5

In the solvent removing step, the coating film formed with the SPE layer precursor was dried in the drying furnace, so as to remove the second and third solvents from the coating film and SPE layer precursor. This yielded a negative electrode comprising a Cu foil, a negative electrode active material layer formed on the surface of the Cu foil, and a solid polyelectrolyte layer formed on the surface of the negative electrode active material layer.

### Comparative Example 1

The negative electrode of Comparative Example 1 was obtained as in Example 1 except that the SPE layer precursor was formed by directly applying the SPE layer coating material to the dry coating film. That is, Comparative Example 1 did not apply the second solvent to the dry coating film and did not press the coating film before the third step.

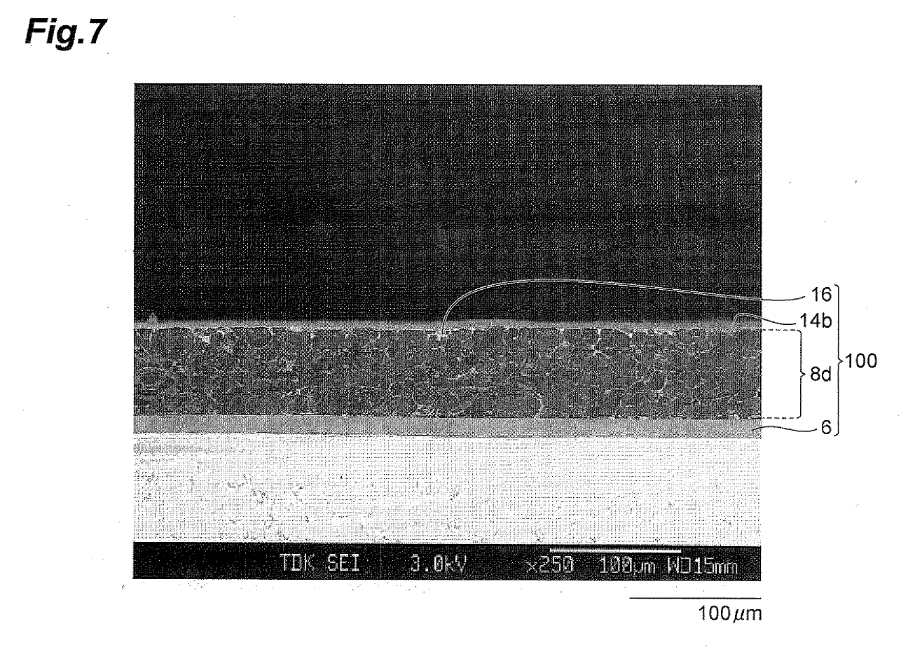

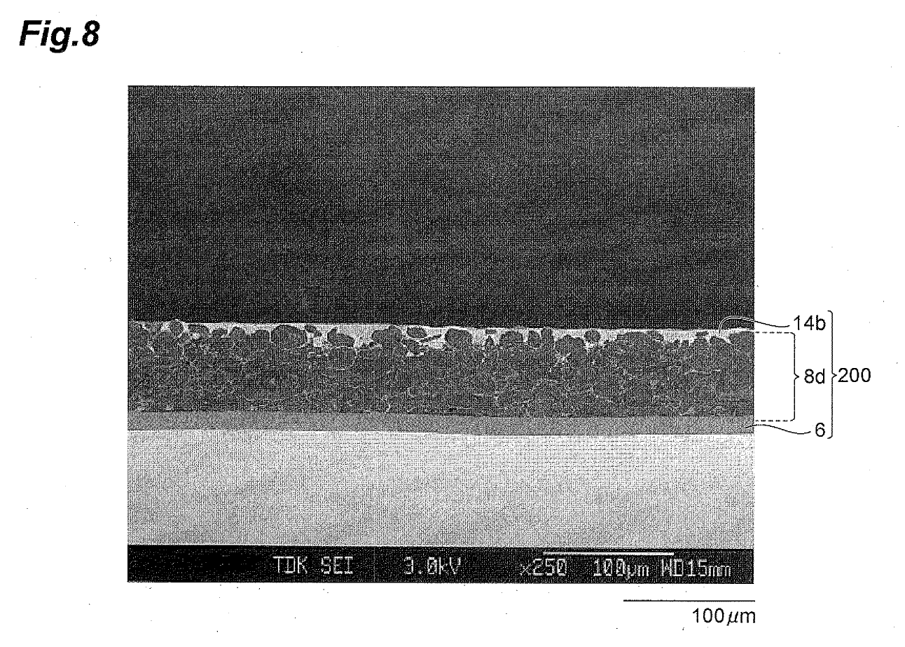

A cross-section of the negative electrode of Example 1 taken along the laminating direction of the Cu foil, negative electrode active material layer, and SPE layer was captured through a transmission electron microscope (SEM), so as to yield a cross-sectional image. FIG. 7 illustrates the result. A cross-sectional image of the negative electrode of Comparative Example 1 was also obtained by the same method as with Example 1. FIG. 8 illustrates the result.

As illustrated in FIG. 7, it was seen that the negative electrode 100 of Example 1 comprised the Cu foil 6; the negative electrode active material layer 8d, formed on the Cu foil 6, containing the active material particles, conductive auxiliary, and active material layer binder; and the SPE layer 14b covering the whole surface of the active material layer 8d and containing the SPE and SPE layer binder. It was also seen that interstices between a plurality of active material particles positioned on the surface of the active material layer 8d on the SPE layer 14b side and the conductive auxiliary were filled with the SPE layer binder 16 in Example 1. It was further seen that the SPE layer 14b was flat and had a uniform thickness.

As illustrated in FIG. 8, it was verified that the negative electrode 200 of Comparative Example 1 comprised the Cu foil 6; the negative electrode active material layer 8d, formed on the Cu foil 6, containing the active material particles, conductive auxiliary, and active material layer binder; and the SPE layer 14b, formed on the active material layer 8d, containing the SPE and SPE layer binder.

However, in contrast to Example 1, the SPE layer binder 16 was not seen between a plurality of active material particles positioned on the surface of the active material layer 8d on the SPE layer 14b side and the conductive auxiliary in Comparative Example 1.

It was seen that the surface of the active material layer 8d incurred irregularities in conformity to the forms of the active material particles and conductive auxiliary in Comparative Example 1. It was also seen that the SPE layer 14b formed on the surface of the active material layer 8d incurred irregularities in conformity to the irregularities on the surface of the active material layer 8d and thus was less flat than in Example 1. It was further seen in Comparative Example 1 that the SPE layer 14b was thinner at protrusions on the surface of the active material layer 8d and retracted into recesses on the surface of the active material layer 8d, whereby the thickness of the SPE layer 14b was less uniform than in Example 1.

What is claimed is:

1. An electrode manufacturing method comprising:
a first step of applying an active material layer coating material containing an active material particle, an active material layer binder, and a first solvent to a current collector so as to form a coating film made of the active material layer coating material;
a second step of applying a second solvent to the coating film; and
a third step of applying a solid polyelectrolyte layer coating material containing a solid polyelectrolyte, a solid polyelectrolyte layer binder, and a third solvent to the coating film coated with the second solvent;
wherein the first solvent is a good solvent for the active material layer binder;
wherein the second solvent is a poor solvent for the solid polyelectrolyte layer binder; and
wherein the third solvent is a good solvent for the solid polyelectrolyte layer binder.

2. An electrode manufacturing method according to claim 1, wherein the first solvent is removed from the coating film before the second step.

3. An electrode manufacturing method according to claim 1, wherein the coating film coated with the second solvent is pressed before the third step.

4. An electrode manufacturing method according to claim 1, wherein the second solvent is a poor solvent for the active material layer binder.

5. An electrode manufacturing method according to claim 1, wherein the solid polyelectrolyte layer binder is polyvinylidene fluoride; and
wherein the second solvent is at least one species selected from the group consisting of water, hexane, toluene, xylene, and alcohol.

6. An electrode manufacturing method according to claim 1, wherein the solid polyelectrolyte contains at least one of polyvinylidene fluoride and polyethylene oxide.

7. An electrode manufacturing method comprising the steps of:
applying an active material layer coating material containing an active material particle, an active material layer binder, and a first solvent to a current collector so as to form a coating film made of the active material layer coating material; and
applying a solid polyelectrolyte layer coating material containing a solid polyelectrolyte, a solid polyelectrolyte layer binder, and a third solvent to the coating film;
wherein the first solvent is a good solvent for the active material layer binder and a poor solvent for the solid polyelectrolyte layer binder; and
wherein the third solvent is a good solvent for the solid polyelectrolyte layer binder.

8. An electrode manufacturing method according to claim 7, wherein the active material layer binder contains styrene-butadiene rubber and carboxymethyl cellulose;
wherein the solid polyelectrolyte layer binder contains at least one of polyvinylidene fluoride and polyethylene oxide; and
wherein the first solvent contains water and alcohol.

9. An electrode manufacturing method according to claim 7, wherein the solid polyelectrolyte contains at least one of polyvinylidene fluoride and polyethylene oxide.

10. An electrode comprising:
a current collector;
an active material layer, formed on the current collector, containing an active material particle and an active material layer binder; and
a solid polyelectrolyte layer, formed on the active material layer, containing a solid polyelectrolyte and a solid polyelectrolyte layer binder;
wherein an interstice between a plurality of active material particles positioned on a surface of the active material layer facing the solid polyelectrolyte layer is filled with the solid polyelectrolyte layer binder.

11. An electrode according to claim 10, wherein the surface of the active material layer facing the solid polyelectrolyte layer, constituted by the plurality of active material particles and the solid polyelectrolyte layer binder filling the interstice between the plurality of active material particles, is substantially parallel to a surface of the solid polyelectrolyte layer opposite from the active material layer.

12. An electrode according to claim 10, wherein the active material particle is constituted by a negative electrode active material.

13. An electrode according to claim 10, wherein the solid polyelectrolyte layer has a thickness of 5 to 30 μm.
